(19) United States
(12) Patent Application Publication
(10) Pub. No.: US 2025/0134154 A1
(43) Pub. Date: May 1, 2025

(54) COOLING MOLD UNIT AND COOLING DEVICE

(71) Applicant: ALPMA Alpenland Maschinenbau GmbH, Rott am Inn (DE)

(72) Inventors: Livio BAUDINO, Mondovì (IT); Enrico PANERO, Borgo San Dalmazzo (IT); Balz BÄHLER, Guntershausen (CH)

(21) Appl. No.: 18/889,721

(22) Filed: Sep. 19, 2024

(30) Foreign Application Priority Data
Oct. 27, 2023 (DE) 102023129693.0

(51) Int. Cl. A23P 30/10; A23C 19/09

(52) U.S. Cl. CPC A23P 30/10; A23C 19/09

(57) ABSTRACT

The invention relates to a cooling mold unit for cooling molded cheese products by means of a cooling liquid, in particular water. It comprises at least one cooling mold, in particular a tubular cooling mold, that can be filled with a cheese mass and that has—in the position of use—an end-face upper opening and an end-face lower opening, at least one tray having at least one leadthrough for receiving the cooling mold, and a base element, in particular a base plate, that is connected to a lower end of the cooling mold and that has at least one recess which is associated with the lower opening and through which the lower opening is accessible. The cooling mold is arranged in the leadthrough, wherein the leadthrough is dimensioned such that an at least sectionally peripheral gap is formed between a margin of the leadthrough and an outer wall of the cooling mold. The present invention further relates to a cooling device for cooling molded cheese products by means of a cooling liquid.

### CROSS-REFERENCES TO RELATED APPLICATIONS

This application claims the benefit of German Application No. 102023129693.0, filed on Oct. 27, 2023. The entire disclosure of the application referenced above is incorporated herein by reference.

The invention relates to a cooling mold unit, comprising at least one cooling mold, and a cooling device for cooling molded cheese products by means of a cooling liquid.

Different systems for the mechanical production of cheese are known from the prior art. Depending on the type of cheese, raw materials are processed in multi-stage processes from intermediate products to finished cheese products.

The production of pasta filata cheese, such as mozzarella (including “low moisture mozzarella”), provolone or kashkaval/kashar, is particularly demanding. The cheeses generally have a dry matter of 45% to 60%, preferably 47% to 56%, but in particular 51% to 55%, and a fat content of 30% to 55%, preferably 40% to 48%, based on the dry matter.

In the production of pasta filata cheese, curd is melted, plasticized, stretched and kneaded in a process step referred to as cooking and stretching. This results in a fiber-like structure that ultimately gives the finished cheese its characteristic elasticity and texture. The plasticized cheese mass obtained during the cooking and stretching is then formed into the desired shape and cooled in a further process step.

For this purpose, the still moldable cheese mass is usually placed in a cooling mold at a temperature of 55° C. to 65° C., usually 58° C. to 63° C., and then cooled. The molded cheese mass is called a molded cheese product. Due to the cooling, the molded cheese product hardens to such an extent that a further processing can take place. The removal of the hardened molded cheese product then takes place during the so-called demolding.

Until now, the cooling of molded cheese products has taken place by means of baths in which cooling molds are stored in water or salt water for cooling, by means of nozzles through which water is sprayed directly onto cooling molds, or also by hollow cooling mold blocks that are flowed through by cooling water and have recesses for molded cheese products. The cooling with nozzles and cooling mold blocks with so-called cooling mold carousels is also known.

The disadvantage of these conventional cooling mold units is that they are not very flexible to use and are difficult to clean. Furthermore, considerable quantities of cooling liquid are required to achieve the desired cooling. In many cases, a contact between the cooling liquid and the product cannot be avoided either. For reasons of food hygiene, the cooling liquid must then often be replaced or cleaned.

The object of the invention is to provide an improved cooling mold unit by which the above-mentioned disadvantages are avoided.

The object is satisfied by the features of claim 1.

A cooling mold unit according to the invention comprises at least one cooling mold that can be filled with a cheese mass and that has an end-face upper opening—i.e. an opening that is arranged at an upper end of the cooling mold in the position of use—and an end-face lower opening—i.e. an opening that is arranged at a lower end of the cooling mold in the position of use—, at least one tray having at least one leadthrough for receiving the cooling mold, and a base element that is connected to the lower end of the cooling mold and that has at least one recess which is associated with the lower opening and through which the lower opening is accessible. The cooling mold is arranged in the leadthrough and the leadthrough is dimensioned such that an at least sectionally peripheral gap is formed between a margin of the leadthrough and an outer wall of the cooling mold. In particular, the gap is substantially completely peripheral (i.e. apart from selective contacts or short contact sections between the cooling mold and the tray). The contact points or contact sections can, for example, make up less than 10%, preferably less than 5%, of the periphery of the cooling mold.

To cool the cooling mold unit, it is acted on by cooling liquid—usually water—so that at least a portion of the cooling liquid, in particular the entire cooling liquid, enters the tray of the cooling mold unit. The cooling liquid collected in the tray flows by gravity through the at least one gap between the leadthrough and the cooling mold and areally down the outer wall of the cooling mold, whereby the cooling mold and thus the molded cheese product located therein are cooled without contact with the cooling liquid (trickle film cooling). For an efficient cooling and for reasons of food hygiene, the cooling mold—and the other components of the unit—can be made of a material that conducts heat well and is also corrosion-resistant and easy to clean, preferably stainless steel.

If the gap is largely continuous in the peripheral direction, it can easily be ensured that a practically full-surface liquid film forms at the outer side of the cooling mold and ensures a good cooling with a comparatively low coolant consumption (trickle film cooling).

The feed of the cooling liquid can be designed such that a certain cooling liquid filling level is always present in the tray. It can thereby be ensured that a sufficient amount of cooling liquid reaches all the gaps and that all the cooling molds are substantially uniformly cooled. The tray can have a margin, in particular an interruption-free margin, that has a suitable height so that the desired filling level can be reached. The tray can be a single-piece component that is formed from a sheet metal part, for example.

The design according to the invention of the cooling mold unit is structurally simple and easy to clean. By areally wetting the cooling molds, an efficient cooling is achieved that ultimately reduces the energy consumption of the corresponding cooling device in which the cooling mold unit is used.

Advantageous embodiments of the invention are also given in the dependent claims, in the description and in the Figures.

In some embodiments of the cooling mold unit according to the invention, in the gap between the cooling mold and the tray, at least one spacer is provided that predefines a gap width and that is releasably and/or fixedly arranged at the cooling mold and/or the tray. The spacer can in particular be formed in one piece with the cooling mold and/or the tray. It can also be a separate component. For example, the spacer is designed as a rib or a projection. The spacer stabilizes the cooling mold in the leadthrough and simultaneously ensures the desired dimensioning of the gap.

The spacer can be fixedly connected to both the tray and the cooling mold. Preferably, however, it is only fixedly connected to one of the two components mentioned so that thermal effects can be absorbed. For example, once filled, the cooling molds are usually significantly warmer than the rest of the unit so that they thermally “shrink” more than the other components during the cooling of the unit. A “warping” of the cooling mold is thereby also avoided that could otherwise occur if heat is introduced during the production of the cooling mold (e.g. welding process).

According to one embodiment of the cooling mold unit, a plurality of spacers are provided that are arranged distributed in the peripheral direction of the gap. The spacers are in particular regularly distributed to ensure a cooling at the entire periphery of the cooling mold.

In some embodiments of the cooling mold unit, the gap has a gap width of 0.4 mm to 1.2 mm. The gap width preferably amounts to 0.5 mm to 1 mm, in particular 0.7 mm to 0.9 mm.

In particular, a width of the gap is substantially constant (apart from selective contacts or short contact sections between the cooling mold and the tray). The amount of cooling liquid passing through the gap is thereby substantially the same everywhere along the gap, whereby a uniform cooling performance is achieved.

The cooling mold can at least sectionally have a polygonal, circular, square or rectangular cross-section.

The cooling mold can comprise a head section that has the upper opening and that is widened in a funnel shape towards the upper opening. The funnel-shaped widening can serve as an insertion aid for a punch to be inserted into the cooling mold.

An inner side of the cooling mold can be at least sectionally provided, in particular completely provided, with a coating. The coating serves to reduce an adhesion between the cheese mass and the cooling mold. This is advantageous both when filling (“laminar molding”) and when demolding. A lower static friction makes it possible to reduce the force required for demolding. Furthermore, the risk of the surface of the cheese cracking during demolding is reduced. The coating also facilitates the cleaning of the cooling mold. For example, a material such as PTFE can be considered for the coating.

In some embodiments of the cooling mold unit, a lower margin of the head section is arranged at a level between a base of the tray and an upper margin of the tray. Alternatively or additionally, it can be provided that an upper margin of the head section projects beyond the upper margin of the tray to prevent cooling liquid from flowing into the cooling mold from above when the tray is completely filled.

The cooling mold unit can comprise a plurality of leadthroughs and cooling molds that are preferably regularly arranged, in particular in the form of a matrix. For example, a cooling mold unit can have 24 cooling molds that are arranged in a 3 by 8 matrix.

In some embodiments of the cooling mold unit, a placement unit provided with rollers or runners is provided, in particular a plate on which the base element can be releasably arranged. The cooling mold unit can be moved as required using rollers or runners. The placement unit in particular consists of plastic or can be coated with it to reduce the sliding friction when the placement unit is pulled out from under the cooling mold unit or when the cooling mold unit is pushed up onto the placement unit.

To increase the stability of the unit and simplify its handling, the tray and the base element can be fixedly connected to one another by means of at least one frame element.

According to a further embodiment of the cooling mold unit, the base element has drainage openings through which the cooling liquid can run out over a margin of the base element. The drainage openings allow the controlled drainage of the cooling liquid, for example to collect and reuse it.

The present invention further relates to a cooling device for cooling molded cheese products by means of a cooling liquid, in particular by means of water. The cooling device according to the invention comprises at least one cooling mold unit, in particular a cooling mold unit according to at least one of the above-described embodiments, that can be filled with a cheese mass, and at least one rectilinear cooling path along which the at least one cooling mold unit can be moved, wherein the cooling mold unit can at least sectionally be acted on by the cooling liquid along the cooling path.

Cooling paths along which the cooling mold units can be moved in a straight line and can in this respect be cooled with cooling liquid enable a continuous and efficient operation of the cooling device with an optimal space utilization. Such cooling devices are also easily scalable. For example, two or more cooling paths can be arranged next to one another if required.

In some embodiments of the cooling device, at least one tube is provided for applying the cooling liquid to the cooling mold unit and extends at least sectionally along the cooling path, in particular offset in parallel from a longitudinal axis of the cooling path.

The tube can be arranged above an upper margin of the tray of the cooling mold unit, in particular above the upper opening of the cooling mold unit.

It is conceivable that at least one tube is in each case provided at both sides of the cooling path to be able to apply cooling liquid even more uniformly to the cooling mold unit.

The tube can have a plurality of holes for applying cooling liquid to the cooling mold unit, in particular wherein the holes are regularly arranged.

In some embodiments of the cooling device, a first group and a second group of holes are provided that are differently dimensioned and/or are arranged in different angular positions with respect to a peripheral direction of the tube. In cooling mold units of the initially described kind with a matrix arrangement of the cooling molds, the first group of holes can be provided to introduce cooling liquid between the cooling molds. The second group of holes can serve to spray cooling liquid onto the tray in the region of the cooling molds and/or to apply cooling liquid directly to the cooling molds. Due to different angular positions, the application of cooling liquid to the tray at different distances from the tube can be realized.

In some embodiments of the cooling device, at least two cooling sections are provided which are arranged behind one another in the longitudinal direction of the cooling path and in which the cooling mold unit can be cooled to different degrees, in particular with cooling liquid of different temperatures. The different cooling in the regions makes it possible to adapt the cooling process as required and to implement suitable cooling profiles in each case. For example, a section can be cooled more intensively if the molded cheese product already has a largely stable structure.

The invention will be described in the following by way of example with reference to the Figures. There are shown:

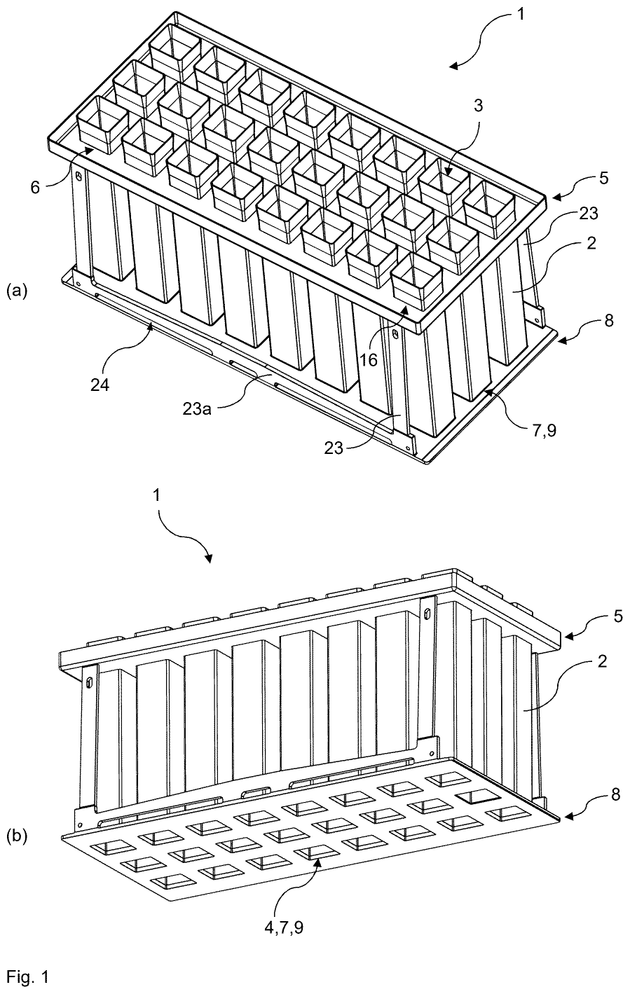

FIG. 1 an embodiment example of a cooling mold unit according to the invention, respectively in a perspective representation (a) from above and (b) from below;

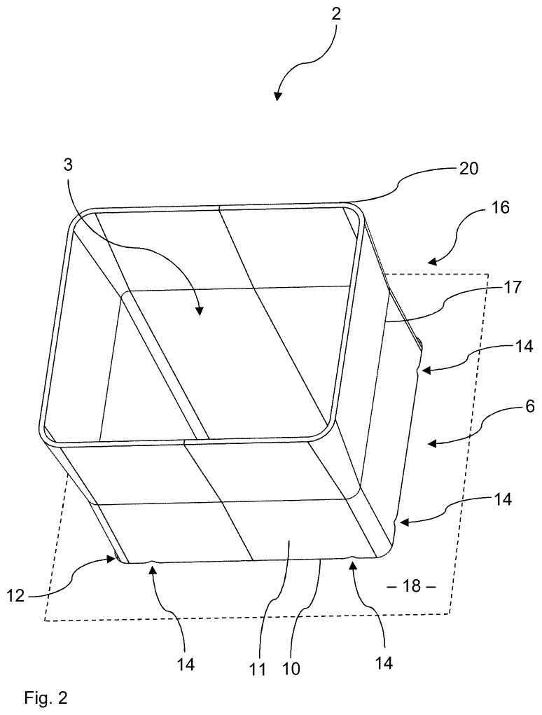

FIG. 2 the head section of a cooling mold in a perspective representation; said head section projecting from above from a leadthrough of the tray;

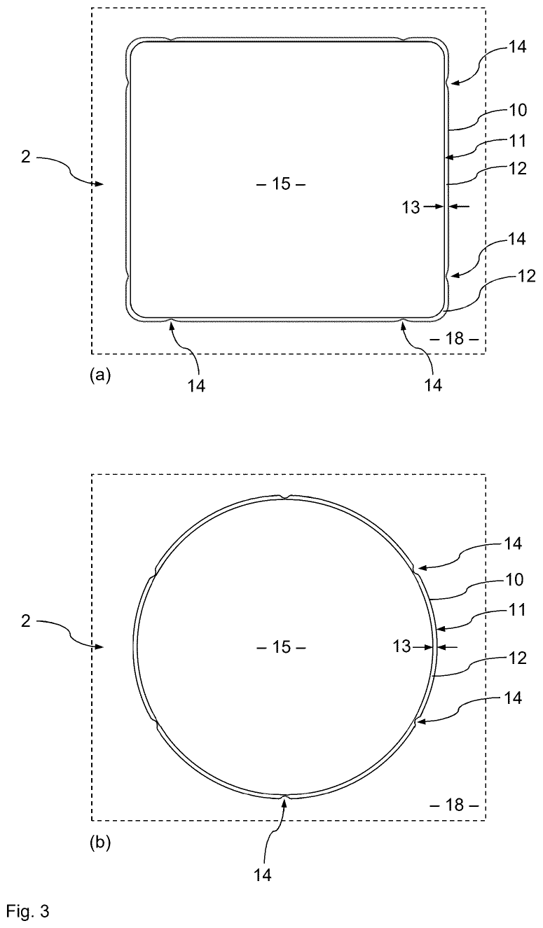

FIG. 3 schematically, a plan view of a cooling mold with (a) a rectangular cross-section and (b) a circular cross-section;

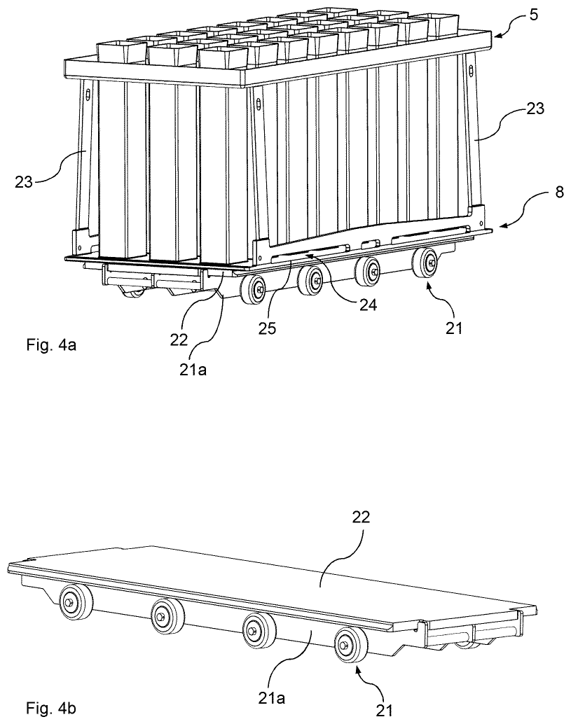

FIG. 4a an embodiment example of a cooling mold unit according to the invention with a placement unit in a perspective representation;

FIG. 4b the placement unit of FIG. 4a;

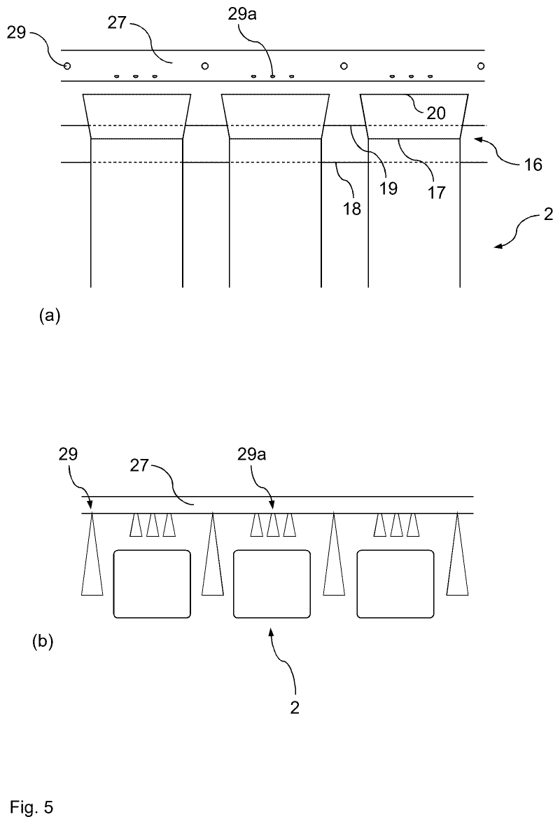

FIG. 5 schematically, a section of a cooling device according to the invention (a) in a side view and (b) in a plan view;

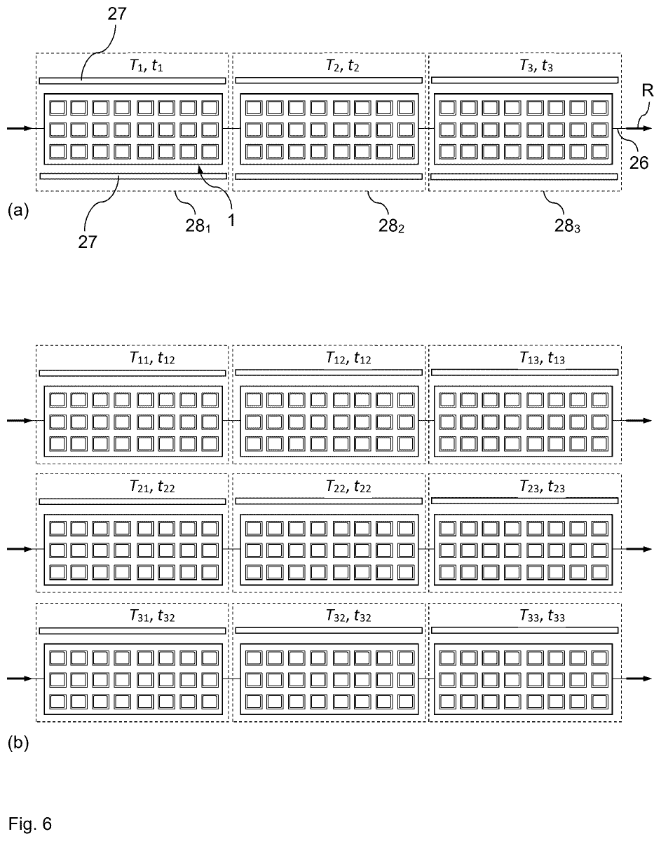

FIG. 6 schematically, a plan view of (a) one cooling path and (b) three cooling paths of a cooling device according to the invention;

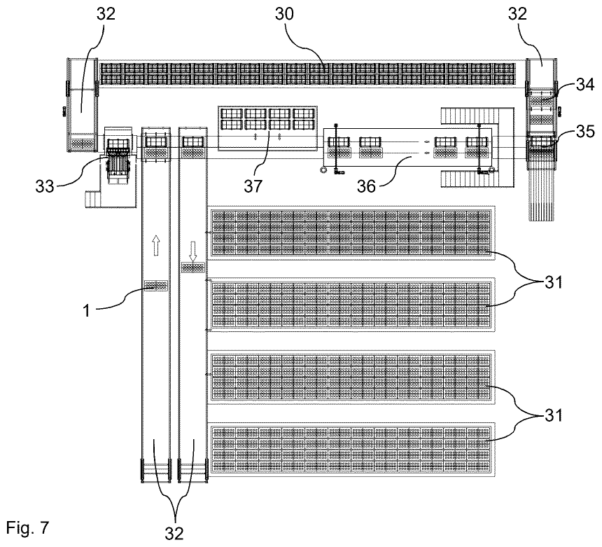

FIG. 7 schematically, an embodiment example of a cooling system with a cooling device according to the invention in a plan view; and

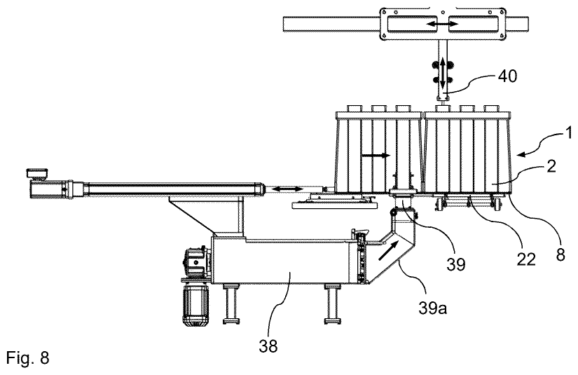

FIG. 8 schematically, a side view of an embodiment example of a molding device with a cooling molding unit according to the invention.

FIG. 1a shows a perspective view of a cooling mold unit 1. The cooling mold unit 1 comprises a tray 5 having leadthroughs 6 which are arranged in a matrix-like manner and in which tubular cooling molds 2 are arranged. The cooling molds 2 have—in the top position of use at the top—in each case an end-face upper opening 3 and—in the position of use at the bottom—an end-face lower opening 4, which can be seen in FIG. 1b. At a lower end 7 of the cooling molds 2, they are welded to a base element 8, designed as a base plate here. The base element 8 has, corresponding to the leadthroughs 6, recesses 9 that are arranged in a matrix-like manner and whose shape corresponds to the lower opening 4 of the cooling molds so that the cooling molds 2 are accessible through the recesses 9.

An upper end of the cooling molds 2 projects from the tray 5 in each case. The upper end comprises a head section 16 described in more detail below.

The tray 5 and the base plate 8 are rigidly connected (e.g. screwed and/or welded) to one another with frame elements 23. The frame elements 23 are coupled (e.g. screwed and/or welded) with cross members 23a that are fastened (e.g. screwed and/or welded) to the base element 8 or formed in one piece therewith.

Water (or another cooling liquid) is applied to the tray 5 to cool the molds 2 arranged in a matrix-like manner. The aim here is to reach a certain water level. The water flows out of the tray 5 (only a part of a base 18 of the tray can be seen in FIG. 2) through a gap 12, which is visible in FIG. 2, between an outer wall 11 of the cooling mold 2 and a margin 10 of the leadthrough 6 and flows downwardly areally at the outer wall 11 of the cooling mold 2 until it impacts the base element 8. From there, the water runs off over margins of the base element 8, including through drainage openings 24 that are provided in the cross members 23a.

A cooling mold unit 1 typically comprises twenty-four cooling molds 2 and has a length of more than 1 m (e.g. approximately 1.3 m) and a width of 0.5 m to 1 m (e.g. approximately 0.6 m). A cooling mold typically has a height of between 0.05 m and 1.2 m, preferably 0.3 m to 0.5 m. It is understood that the dimensions can be selected as required.

The head section 16 shown in FIG. 1a and the gap 12 not visible there are shown in more detail in FIG. 2. The head section 16 of the cooling mold 2 projects through the leadthrough 6 of the base 18 of the tray 5. A region of the base 18 around the leadthrough 6 is indicated by the dashed line here. Spacers 14 configured as projections of the tray 5 extend into the leadthrough 6 and define a gap width 13 (see FIG. 3). The spacers/projections 14 therefore define the gap 12 whose width 13 is substantially constant in the peripheral direction. The tray 5 and the cooling molds 2 only touch at the spacers 14. The projections 14 are not fixedly connected to the cooling mold 11 to allow (slight) relative movements that occur, for example, due to thermal effects. For example, a distortion is avoided, which could otherwise occur due to a high heat input during a welding process in the manufacture of the cooling mold unit 1.

The gap 12 is in particular visible at the bottom left-hand corner of the leadthrough 6.

The head section 16 has a lower margin 17 and an upper margin 20 between which it widens in a funnel shape.

FIGS. 3a and 3b schematically show plan views of a section of a cooling mold unit 1 with the base 18 of the tray 5 and of a cooling mold 2 projecting through the leadthrough 6 of the tray 5, with the base 18 being indicated by the dashed line. The cooling mold 2 of FIG. 3a has a rectangular cross-section 15 and the cooling mold 2 of FIG. 3b has a circular cross-section 15. Other cross-sectional shapes are conceivable.

As already described, the gap 12 is in each case formed between the outer wall 11 of the cooling mold 2 and the margin 10 of the leadthrough 6 of the tray 5. The spacers 14 are arranged regularly distributed in the peripheral direction of the gap 12 and are configured as projections of the tray base 18.

The gap width 13 of the gaps 12 is substantially constant over the periphery of the cooling mold 2. The spacers 14 can also be designed as a rib and/or a separate component.

In FIG. 4a, a cooling mold unit 1 is shown with a placement unit 22 on which the base element 8 rests. The placement unit 22 is designed as a plate here and is provided with rollers 21 so that the unit 1 can be moved. The rollers 21 are arranged at a chassis 21a (usually substantially made of stainless steel) that is releasably connected to the plate 22 to enable a separate cleaning.

The placement unit 22 is shown separately in FIG. 4b. The cooling molds 2 are filled from below and are then pushed onto the placement unit 22 so that a cheese mass projecting from the lower openings 4 of the cooling molds 2 is sheared off.

The placement unit 22 is, for example, a plastic plate with a small coefficient of sliding friction to facilitate the lateral pushing on of the cooling molds 2. However, it can also comprise a coated stainless steel plate, wherein the coating is applied such that a stainless steel-to-stainless steel contact with the chassis 21a is avoided, which could lead to scratches or the like that are difficult to clean and/or that form a gateway for corrosion.

A side view of a section of a cooling device according to the invention is schematically shown in FIG. 5a. Above the upper margin 20 of the head section 16 of the cooling molds 2 of a cooling mold unit 1 there is a tube 27 for applying water to the cooling mold unit 1. The tube 27 has a first group of holes 29 and a second group of holes 29a that are differently dimensioned and are arranged in different angular positions with respect to a peripheral direction of the tube 27. Furthermore, the groups of holes 29, 29a are regularly arranged. The horizontal positioning of the second group of holes 29a coincides with the horizontal positioning of the cooling molds 2 of the cooling mold unit 1 when it is in a discrete cooling position. The first group of holes 29 are positioned such that water exiting from them enters spaces between the cooling molds 2.

As already described, the cooling molds 2 have a head region 16 that projects beyond the base 18 of the tray. The lower margin 17 of the head region 16 is located between the base 18 and an upper margin 19 of the tray 5. The upper margin 20 of the head region 16 is located at a level between the upper margin 19 of the tray 5 and the tube 27.

The application of water to the tray 5 of the cooling mold unit 1 takes place as shown in FIG. 5b. The water jets emerging from the holes 29, 29a are schematically indicated as cones. The water exits through the holes 29, 29a such that the holes 29 of the first group act on the base 18 of the tray 5 in the longitudinal direction between the cooling molds 2 and the holes 29a of the second group act on the base 18 in a region to the side of the cooling molds 2. Through the holes 29, not only is cooling liquid applied to a marginal region of the base 18, but cooling water is also supplied to a central region so that a sufficient amount of water can be supplied to all the gaps 12.

However, the groups of holes 29, 29a can also have more or fewer holes than shown and can also be positioned in different angular positions. For example, the first group of holes 29 has a diameter of 6 mm and the second group of holes 29a has a diameter of 3.5 mm. The arrangement of the holes 29, 29a ensures that no cooling water enters the cooling molds 2 through the opening 3. To ensure this even when the unit 1 is moved from one discrete position to the next, the supply of cooling water can be interrupted or throttled in the meantime.

A cooling path 26 of a cooling device according to the invention is schematically shown in a plan view in FIG. 6a. The cooling path 26 has cooling sections 28₁, 28₂ and 283 arranged behind one another in the transport direction R. The number of cooling sections depends on the specific requirements. The units 1 to be cooled are moved into the next cooling section after a predetermined time interval. A cycled cooling during which the units 1 each occupy a plurality of discrete cooling positions therefore took place.

Each cooling section 28₁, 28₂ and 28₃ comprises two parallel tubes 27 for applying water to the cooling mold unit 1. The tubes 27 are arranged at both sides of the cooling units 1 to also be able to apply water to said cooling units from both sides. The water has a different temperature (T₁, T₂ and T₃) in each section. The cooling mold unit 1 can be subjected to a different temperature in each region so that the temporal temperature development of a molded cheese product in a cooling mold 2 can be intentionally influenced by selecting the temperature of the cooling water.

Three cooling paths 26 of a cooling device 30 according to the invention that extend in parallel are schematically shown in FIG. 6b. The cooling paths 26 extending in parallel each have three cooling sections. This purely exemplary configuration makes it clear that the cooling device can be easily scaled by adapting the number of cooling paths 26 in order to generate a desired throughput. In contrast to the embodiment shown in FIG. 6a, in each case only one tube 27 is associated with each cooling path 26. However, it is understood that in the cooling device 30 of FIG. 6b, a water application at both sides in accordance with FIG. 6a can be provided, i.e. each cooling path 26 has cooling tubes 27 at both sides of the cooling units 1. A water application at both sides can also be achieved if adjacent cooling paths 26 are in each case assigned common cooling tubes 27 that supply cooling units 1 arranged next to one another with water.

A cooling system comprising a cooling device 30 according to the invention and cooling mold units 1 is shown in FIG. 7. The cooling system comprises a plurality of buffer stores 31 for storing the cooling mold units 1, a molding device 33 for molding a cheese mass into the cooling molds 2 of the cooling mold units 1, a cooling device 30 for cooling molded-in molded cheese products, a heating device 34 for briefly applying a hot liquid to the cooling molds 2, in particular water, or steam, in particular water vapor, to partly melt an outermost layer of the molded cheese products and to facilitate a subsequent demolding, a demolding device 35 for demolding the molded cheese products, a cleaning device 30 for cleaning empty cooling mold units 1, and a storage device 37 for storing the placement units 22. Transport devices 32 serve to transport the cooling mold units 1 between the individual stations of the system.

An empty cooling mold unit 1 is transported from one of the storage devices 31 by the transport device 32 to the molding device 33, where cheese mass is introduced into the cooling molds 2 of the cooling mold unit 1. Subsequently, the filled cooling mold unit 1 is transported to the cooling device 30 and is fed to one of possibly a plurality of cooling paths 26 there. The cooling path 26 can consist of one or more cooling sections 28. The application of cooling water to the filled cooling mold unit 1 can take place in the manner described above.

The typically targeted core temperature of the molded cheese products after cooling is around 35° C. to 55° C. The cooling time inter alia depends on the size of the molded cheese products and is typically between 20 min and 90 min, in particular 25 min to 40 min, preferably 25 min to 40 min.

After the cooling process, the cooling mold unit 1 is fed by means of a transport device 32 to the optional heating device 34, where the cooling mold unit 1 is briefly acted on by hot liquid and/or hot gas and/or hot steam. The radially outermost layer of the molded cheese products thereby melts, whereby they are subsequently easier to demold. The brief heating of the molded articles also gives them a smooth surface (a property that is positively received by customers). The hot fluids typically have temperatures of 55° C. to 95° C., preferably 65° C. to 75° C.

The application of heat typically only lasts 2 s to 20 s, preferably 5 s to 15 s, since there is a risk with a too long heating that the molded cheese products will become too soft or sticky again.

In the adjoining demolding unit 35, the placement unit 22 is removed from under the cooling mold unit 1. By means of punches, not shown, which are inserted from above into the cooling molds 2, the molded cheese products are pushed out of the cooling molds 2 and fed to a conveying device, not shown here. The conveying device can be a conveyor belt or a floating channel, for example.

After the demolding, the molded cheese products can, for example, be cooled again, in particular in salt baths. Provision can also be made to smoke or otherwise treat the molded articles before they are packaged.

The empty cooling mold unit 1 and the placement unit 22 are cleaned in the cleaning device 36. For this purpose, the cooling mold unit 1 is tilted out of the position of use, for example by 170 degrees to 180 degrees, to empty its tray 5 quickly and prevent a carry-over of cleaning agent. The cleaned cooling mold unit 1 can then be fed to the storage device 31 by the transport device 32 or can immediately be refilled.

The cooling mold unit 1 is thus fed into a continuous cycle in which a molding, cooling and demolding take place. Cleaning the empty cooling mold units 1 is likewise part of this continuous cycle. The cooling device and/or transport paths for the cooling mold units 1 of the cycle are preferably designed so that all the cooling mold units can be transported or moved out for their cleaning. The plurality of storage devices 31 can be used for cooling mold units 1 with different cooling molds 2 (“formats”). Another set of cooling mold units 1, which are kept available in the devices 31, is simply used for a format change. Only minor modifications to the molding device 33 may be necessary (see below). If the external dimensions of the cooling mold units 1 remain the same, no modifications need to be provided for a format change if the holes 29, 29a are suitably arranged. Provision can also be made that different groups of holes 29, 29a are present that are closed, opened and/or throttled depending on the format. It is also possible to provide format-specific tubes 27 with suitable holes 29, 29a that are used when changing formats.

Cooling mold units 1, each having different cooling molds 2, can also be simultaneously cooled in the cooling system 30.

A section of the molding device 33 is schematically shown in FIG. 8. The molding device 33 comprises a conveying device 38, in particular a screw conveyor, for introducing a cheese mass into the cooling molds 2 of the cooling molding unit 1 that are arranged in a matrix. The mass is pressed “column-wise” from below into the cooling molds 2 in which horizontally and vertically movable punches 40 are arranged. When introducing the cheese mass, the punches 40 exert a suitable counterforce that contributes to a uniform molding of the cheese mass and largely suppresses the formation of air pockets. The cheese mass is typically molded at a temperature between 55° C. and 65° C.

An empty cooling mold unit 1 is pushed from the left via a row of nozzles 39 that are disposed behind one another perpendicular to the image plane and that are arranged at discharge sections 39a of one or more conveying devices 38 such that openings of the nozzles 39 are aligned with a row of recesses 9 of the base element 8 disposed behind one another. A row of punches 40 disposed behind one another perpendicular to the drawing plane is inserted from above into the row of cooling molds 2 to be filled up to their lower ends 7. The conveying device 38 then presses a cheese mass from below into the cooling molds 2, while the punches 40 exert a counterforce on the cheese masses from above. The conveying device 38 conveys the cheese mass until the punches 40 impact an abutment, not shown. The impact is detected and a signal is then sent to the conveying device 38 so that the conveying of the cheese mass is stopped. The cooling mold unit 1 is then moved further to the right with the punch 40 at the abutment just mentioned until the next row of cooling molds 2 contacts the nozzle 39 of the conveying apparatus 38 (state shown in FIG. 8). Only then are the punches 40 pulled out of the cooling molds 2 just filled and are inserted into the next row of cooling molds 2 via the nozzle 39 to fill this exact row of cooling molds 2. This means that the punches 40 remain in the cooling molds 2 during the lateral displacement of the cooling mold unit 1. This measure ensures that the molded articles are stabilized during the advancement.

By pushing the cooling mold unit 1 onto the placement unit 22, a cheese mass projecting downwardly from the cooling mold 2 is sheared off. As soon as the last row of cooling molds 2 of a cooling mold unit 1 has been filled and the latter has been pushed onto the placement unit 22, the cooling mold unit 1 together with the placement unit 22 is fed to the cooling device 30 by the conveying device 32. An adjoining cooling mold unit 1 can optionally be used to advance a cooling mold unit 1 that has to be filled or has been filled.

When changing formats, only the nozzles 39 need to be replaced. Aperture-like replacement parts can also be provided that adapt a cross-section of an output-side end of the discharge sections 39a of the conveying apparatus 38 to the cross-section of the cooling molds 2 just inserted.

In summary, it can be stated that the cooling mold unit according to the invention enables a uniform and efficient cooling so that the cooling water consumption, and thus also the energy consumption, of a corresponding system is reduced. The unit and the cooling device according to the invention enable a continuous operation in which the contamination of the molded cheese products with cooling water is also avoided. The cooling mold units can also be easily cleaned after each cooling cycle.

The cooling mold unit according to the invention and the cooling device according to the invention furthermore enable a comparatively simple and quick format change. It is also possible to adapt the cooling times to the respective present requirements and to “run” suitable cooling profiles.

It is understood that the cooling mold unit according to the invention can also be used in cooling devices that do not have rectilinear translatory cooling paths. They can generally also be used with carousel-like cooling devices.

### REFERENCE NUMERAL LIST

1 cooling mold unit
2 cooling mold
3 end-face upper opening of the cooling mold
4 end-face lower opening of the cooling mold
5 tray
6 leadthrough
7 lower end of the cooling mold
8 base element, plate
9 recess
10 margin of the leadthrough
11 outer wall
12 gap
13 gap width
14 spacer/projection
15 cross-section of the cooling mold
16 head section of the cooling mold
17 lower margin of the head section
18 base of the tray
19 upper margin of the tray
20 upper margin of the head section
21 rollers
21a chassis
22 placement unit
23 frame element
23a cross member
24 drainage openings
25 margin of the base element
26 cooling path
27 tube
28 cooling section
29, 29a first and second group of holes
30 cooling device
31 storage device for cooling mold units
32 transport device
33 molding device
34 heating device
35 demolding device
36 cleaning device
37 storage device for placement units
38 conveying apparatus for cheese mass
39 nozzle
39a discharge section
40 punch

1. A cooling mold unit for cooling molded cheese products by means of a cooling liquid, said cooling mold unit comprising:
at least one cooling mold that can be filled with a cheese mass and that has—in the position of use—an end-face upper opening and an end-face lower opening, at least one tray having at least one leadthrough for receiving the cooling mold, and
a base element that is connected to a lower end of the cooling mold and that has at least one recess which is associated with the lower opening and through which the lower opening is accessible,
wherein the cooling mold is arranged in the leadthrough, and
wherein the leadthrough is dimensioned such that an at least sectionally peripheral gap is formed between a margin of the leadthrough and an outer wall of the cooling mold.

2. The cooling mold unit according to claim 1,
wherein the at least one cooling mold is a tubular cooling mold.

3. The cooling mold unit according to claim 1,
wherein the base element is a base plate.

4. The cooling mold unit according to claim 1,
wherein, in the gap between the cooling mold and the tray, at least one spacer is provided that predefines a gap width and that is releasably and/or fixedly arranged at the cooling mold and/or the tray.

5. The cooling mold unit according to claim 4,
wherein the spacer is designed as a rib, a projection and/or a separate component.

6. The cooling mold unit according to claim 4,
wherein a plurality of spacers are provided that are arranged distributed in the peripheral direction of the gap.

7. The cooling mold unit according to claim 6,
wherein the plurality of spacers are regularly distributed provided in the peripheral direction of the gap.

8. The cooling mold unit according to claim 1,
wherein the gap has a gap width of 0.4 mm to 1.2 mm.

9. The cooling mold unit according to claim 1,
wherein a width of the gap is substantially constant.

10. The cooling mold unit according to claim 1,
wherein the cooling mold at least sectionally has a polygonal, circular, square or rectangular cross-section.

11. The cooling mold unit according to claim 1,
wherein the cooling mold has a head section that comprises the upper opening and that is widened in a funnel shape towards the upper opening.

12. The cooling mold unit according to claim 1,
wherein a lower margin of the head section is arranged at a level between a base of the tray and an upper margin of the tray and/or
wherein an upper margin of the head section projects beyond the upper margin of the tray.

13. The cooling mold unit according to claim 1,
wherein the cooling mold unit comprises a plurality of leadthroughs and cooling molds.

14. The cooling mold unit according to claim 13,
wherein the cooling molds are regularly arranged.

15. The cooling mold unit according to claim 14,
wherein the cooling molds are arranged in the form of a matrix.

16. The cooling mold unit according to claim 1,
wherein a placement unit provided with rollers or runners is provided.

17. The cooling mold unit according to claim 16,
wherein the placement unit is a plate on which the base element can be releasably arranged.

18. The cooling mold unit according to claim 1,
wherein the tray and the base element are fixedly connected to one another by means of at least one frame element.

19. The cooling mold unit according to claim 1,
wherein the base element has drainage openings through which the cooling liquid can run out over a margin of the base element.

20. The cooling mold unit according to claim 1,
wherein an inner side of the cooling mold is at least sectionally provided with a coating.

21. The cooling mold unit according to claim 1,
wherein an inner side of the cooling mold is completely provided with a coating.

22. A cooling device for cooling molded cheese products by means of a cooling liquid, said cooling device comprising:
at least one cooling mold unit that can be filled with a cheese mass,
at least one rectilinear cooling path along which the at least one cooling mold unit can be moved, wherein the cooling mold unit can at least sectionally be acted on by the cooling liquid along the cooling path.

23. The cooling device according to claim 22, wherein said cooling mold unit comprises:
at least one cooling mold that can be filled with a cheese mass and that has—in the position of use—an end-face upper opening and an end-face lower opening,
at least one tray having at least one leadthrough for receiving the cooling mold, and
a base element that is connected to a lower end of the cooling mold and that has at least one recess which is associated with the lower opening and through which the lower opening is accessible,
wherein the cooling mold is arranged in the leadthrough, and
wherein the leadthrough is dimensioned such that an at least sectionally peripheral gap is formed between a margin of the leadthrough and an outer wall of the cooling mold.

24. The cooling device according to claim 22,
wherein at least one tube is provided for applying the cooling liquid to the cooling mold unit and extends at least sectionally along the cooling path.

25. The cooling device according to claim 24,
wherein the at least one tube extends at least sectionally along the cooling path offset in parallel from a longitudinal axis of the cooling path.

26. The cooling device according to claim 24,
wherein the tube is arranged above an upper margin of the tray.

27. The cooling device according to claim 26,
wherein the tube is arranged above the upper opening.

28. The cooling device according to claim 24,
wherein at least one tube is in each case provided at both sides of the cooling path.

29. The cooling device according to claim 24,
wherein the tube has a plurality of holes for applying cooling liquid to the cooling mold unit.

30. The cooling device according to claim 29,
wherein the holes are regularly arranged.

31. The cooling device according to claim 29,
wherein a first group and a second group of holes are provided that are differently dimensioned and/or are arranged in different angular positions with respect to a peripheral direction of the tube.

32. The cooling device according to claim 22,
wherein at least two cooling sections are provided which are arranged behind one another in the longitudinal direction of the cooling path and in which the cooling mold unit can be cooled to different degrees.

33. The cooling device according to claim 22,
wherein at least two cooling sections are provided which are arranged behind one another in the longitudinal direction of the cooling path and in which the cooling mold unit can be cooled to different degrees with cooling liquid of different temperatures.
